(19) United States
(12) Patent Application Publication
(10) Pub. No.: US 2025/0159382 A1
(43) Pub. Date: May 15, 2025

(54) IMAGING SYSTEM

(71) Applicant: Japan Display Inc., Tokyo (JP)

(72) Inventors: Kazuhiko SAKO, Tokyo (JP); Kazunari TOMIZAWA, Tokyo (JP)

(21) Appl. No.: 18/939,767

(22) Filed: Nov. 7, 2024

(30) Foreign Application Priority Data
Nov. 10, 2023 (JP) 2023-192113

(51) Int. Cl. H04N 25/76; H04N 23/55; H04N 23/56; H04N 25/13; H04N 25/71

(52) U.S. Cl. CPC H04N 25/7795; H04N 23/55; H04N 23/56; H04N 25/745; H04N 25/134

(57) ABSTRACT

According to an aspect, an imaging system includes: a display device that includes a display panel on which a plurality of pixels are arranged in a first direction and a second direction intersecting the first direction and a light source configured to emit light to a side surface of the display panel; and an imaging device that is provided with the display panel interposed between the imaging device and a subject and is configured to capture an image of the subject transmitted through the display panel. The display device is configured to have: a first period in which pixel data is written to the pixels; and a second period in which the light source emits the light after the first period. The imaging device is configured to generate imaged data of the subject using exposure data acquired during the first period.

### CROSS-REFERENCE TO RELATED APPLICATION

This application claims the benefit of priority from Japanese Patent Application No. 2023-192113 filed on Nov. 10, 2023, the entire contents of which are incorporated herein by reference.

### BACKGROUND

### 1. Technical Field

What is disclosed herein relates to an imaging system.

### 2. Description of the Related Art

Teleconferencing systems via networks are widely spread. In such a teleconferencing system, an image of a participant captured, for example, by a web camera installed on or embedded in an upper portion of a display monitor is generally displayed on a screen of each terminal device. In such a configuration, a line of sight of a participant viewing the display monitor may not match the line of sight of the participant displayed on the screen, and the quality of communication may deteriorate. For example, a display device with a camera in which an imaging module (camera) is built into a display element (display portion), a communication device, and a communication system are disclosed (for example, in Japanese Patent Application Laid-open Publication No. 2005-176151).

In the conventional technology mentioned above, a display driving of the display element and an imaging driving of the imaging module are alternately performed. This operation causes flickering of a displayed image and a captured image, and may cause deterioration in display quality and imaging quality.

For the foregoing reasons, there is a need for an imaging system capable of remotely displaying high-quality images.

### SUMMARY

According to an aspect, an imaging system includes: a display device that includes a display panel on which a plurality of pixels are arranged in a first direction and a second direction intersecting the first direction and a light source configured to emit light to a side surface of the display panel; and an imaging device that is provided with the display panel interposed between the imaging device and a subject and is configured to capture an image of the subject transmitted through the display panel. The display device is configured to have: a first period in which pixel data is written to the pixels; and a second period in which the light source emits the light after the first period. The imaging device is configured to generate imaged data of the subject using exposure data acquired during the first period.

### BRIEF DESCRIPTION OF THE DRAWINGS

FIG. 1 is a diagram illustrating a schematic configuration of an imaging system according to an embodiment of the present disclosure;

FIG. 2 is a schematic circuit diagram illustrating a main configuration of a display device;

FIG. 3 is a schematic sectional view of a display panel;

FIG. 4 is a timing diagram illustrating sub-frame periods and light emission periods in a one-frame period during which display image data is displayed;

FIG. 5 is a diagram illustrating a color filter array of an image sensor;

FIG. 6 is a timing diagram illustrating an example of acquisition timing of imaged data according to a first embodiment of the present disclosure;

FIG. 7 is a timing diagram illustrating an example of the acquisition timing of the imaged data according to a comparative example;

FIG. 8 is a timing diagram illustrating an example of the acquisition timing of the imaged data according to a modification of the first embodiment;

FIG. 9 is a diagram illustrating a schematic configuration of an imaging system according to a second embodiment of the present disclosure;

FIG. 10 is a timing diagram illustrating an example of the acquisition timing of the imaged data according to the second embodiment;

FIG. 11 is a timing diagram illustrating an example of the acquisition timing of the imaged data according to a modification of the second embodiment;

FIG. 12 is a timing diagram illustrating an example of the acquisition timing of the imaged data according to a third embodiment of the present disclosure;

FIG. 13 is a diagram illustrating an imaging area that overlaps the display panel when an imaging device acquires exposure data in the third embodiment;

FIG. 14 is a timing diagram illustrating an example of the acquisition timing of the imaged data according to a modification of the third embodiment;

FIG. 15 is a diagram illustrating the imaging area that overlaps the display panel when the imaging device acquires the exposure data in the modification of the third embodiment; and

FIG. 16 is a diagram illustrating a modification of the color filter array of the image sensor.

### DETAILED DESCRIPTION

The following describes modes (embodiments) for carrying out the present disclosure in detail with reference to the drawings. The present disclosure is not limited to the description of the embodiments to be given below. Components to be described below include those easily conceivable by those skilled in the art or those substantially identical thereto. In addition, the components to be described below can be combined as appropriate. What is disclosed herein is merely an example, and the present disclosure naturally encompasses appropriate modifications easily conceivable by those skilled in the art while maintaining the gist of the disclosure. To further clarify the description, the drawings schematically illustrate, for example, widths, thicknesses, and shapes of various parts as compared with actual aspects thereof, in some cases. However, they are merely examples, and interpretation of the present disclosure is not limited thereto. The same element as that illustrated in a drawing that has already been discussed is denoted by the same reference numeral through the description and the drawings, and detailed description thereof will not be repeated in some cases where appropriate.

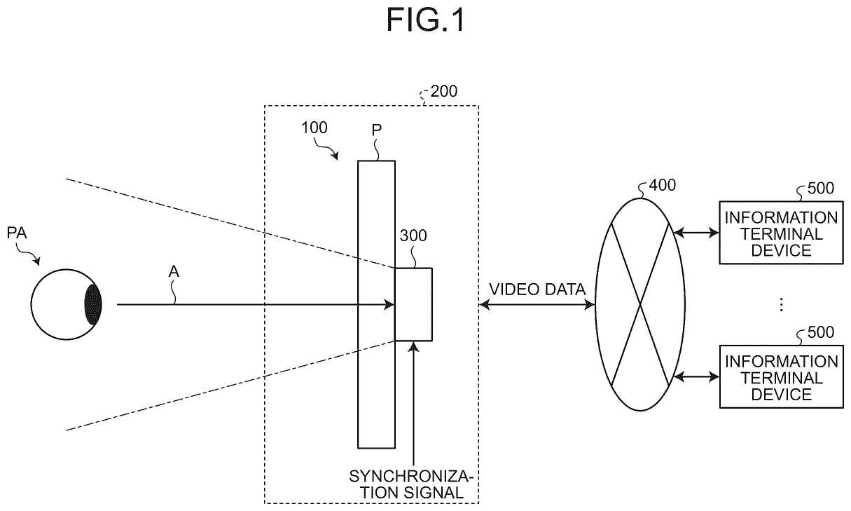

FIG. 1 is a diagram illustrating a schematic configuration of an imaging system according to an embodiment of the present disclosure. As illustrated in FIG. 1, an imaging system 200 according to the embodiment includes a display device 100 and an imaging device 300.

In the present disclosure, the display device 100 is a transmissive liquid crystal display device that performs display output using what is called a field-sequential color (FSC) system to control pixels so that light in a plurality of colors is transmitted through the same pixels at times different from one another.

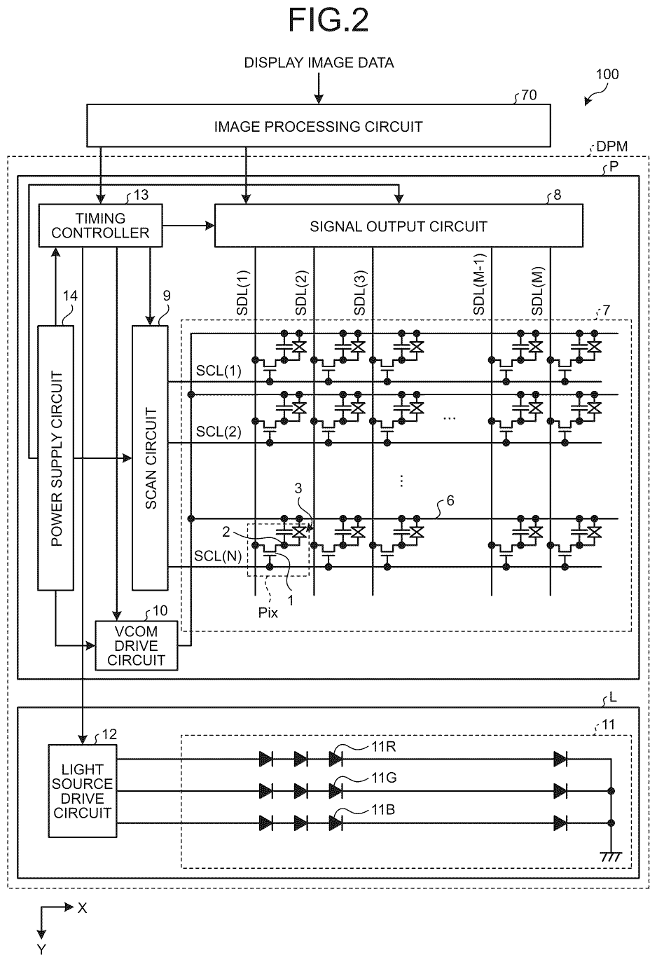

FIG. 2 is a schematic circuit diagram illustrating a main configuration of the display device. The display device 100 includes a display panel module DPM and an image processing circuit 70. The display panel module DPM includes a display panel P and a light source device L.

The display panel P includes a display area 7, a signal output circuit 8, a scan circuit 9, a VCOM drive circuit 10, a timing controller 13, and a power supply circuit 14. Hereafter, one surface of the display panel P as the front side of the display area 7 is referred to as a “display surface” and the other surface is referred to as a “back surface”. A lateral side of the display device 100 refers to a side located, with respect to the display device 100, in a direction intersecting (for example, orthogonal to) a direction in which the display surface and the back surface face each other.

A plurality of pixels Pix are arranged in a matrix having a row-column configuration in an X direction (first direction) and a Y direction (second direction) in the display area 7. The Y direction (second direction) is a direction intersecting the X direction (first direction). More specifically, in the example illustrated in FIG. 2, the Y direction (second direction) is a direction orthogonal to the X direction (first direction).

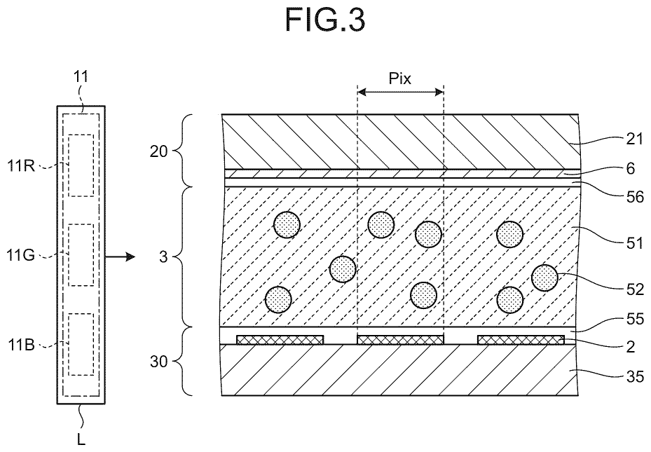

Each of the pixels Pix includes a switching element 1 and two electrodes. FIG. 3 is a schematic sectional view of the display panel. FIGS. 2 and 3 illustrate a pixel electrode 2 and a common electrode 6 as two electrodes. The display panel P includes two substrates facing each other and liquid crystals 3 enclosed between the two substrates. Hereinafter, one of the two substrates is referred to as a first substrate 30, and the other of them is referred to as a second substrate 20.

The first substrate 30 includes a light-transmitting glass substrate 35, the pixel electrode 2 stacked on the second substrate 20 side of the glass substrate 35, and an insulating layer 55 stacked on the second substrate 20 side so as to cover the pixel electrode 2. The pixel electrode 2 is individually provided for each of the pixels Pix. The second substrate 20 includes a light-transmitting glass substrate 21, the common electrode 6 stacked on the first substrate 30 side of the glass substrate 21, and an insulating layer 56 stacked on the first substrate 30 side of the common electrode 6 so as to cover the common electrode 6. The common electrode 6 has a plate-like or film-like shape shared among the pixels Pix.

The liquid crystals 3 of the first embodiment are polymer-dispersed liquid crystals (PDLCs). In other words, in the present embodiment, the display panel P is a liquid crystal panel in which the polymer-dispersed liquid crystals are enclosed. Specifically, the liquid crystals 3 contain a bulk 51 and fine particles 52. The fine particles 52 change in orientation in the bulk 51 in accordance with a potential difference between the pixel electrode 2 and the common electrode 6. The scattering state of the liquid crystals 3 is controlled for each of the pixels Pix by individually controlling the potential of the pixel electrode 2 of each of the pixels Pix.

FIG. 3 illustrates the example in which the pixel electrode 2 and the common electrode 6 are arranged so as to face each other with the liquid crystals 3 interposed therebetween. However, the display panel P may be configured such that the pixel electrode 2 and the common electrode 6 are provided on one substrate, and an electric field generated by the pixel electrode 2 and the common electrode 6 changes the orientation of the liquid crystals 3 and thus controls the scattering state of the liquid crystals 3.

The following describes a mechanism to control potentials of the pixel electrode 2 and the common electrode 6.

The switching element 1 is a switching element using a semiconductor such as a thin-film transistor (TFT). One of the source and the drain of the switching element 1 is coupled to one of the two electrodes (pixel electrode 2). The other of the source and the drain of the switching element 1 is coupled to a signal line SDL(m) (m is an integer in a range from 1 to M, where M is a total number of the signal lines). The gate of the switching element 1 is coupled to a scan line SCL(n) (n is an integer in a range from 1 to N, where N is a total number of the scan lines). Under the control of the scan circuit 9, the scan line SCL(n) applies a potential to open or close a circuit between the source and the drain of the switching element 1. The scan circuit 9 controls the potential.

In the example illustrated in FIG. 2, a plurality of the signal lines SDL(n) are arranged along one of the arrangement directions (row direction) of the pixels Pix. The signal line SDL(m) extends along the other of the arrangement directions (column direction) of the pixels Pix. The signal line SDL(m) is shared by the switching elements 1 of the pixels Pix arranged in the column direction. A plurality of the scan lines SCL(n) are arranged along the column direction. The scan line SCL(n) extends along the row direction. The scan line SCL(n) is shared by the switching elements 1 of the pixels Pix arranged in the row direction.

In the present disclosure, the X direction (first direction) refers to the direction in which the scan line SCL(n) extends, and the Y direction (second direction) refers to the direction in which the scan lines SCL(n) are arranged.

The common electrode 6 is coupled to the VCOM drive circuit 10. The VCOM drive circuit 10 applies a common potential to the common electrode 6.

The scan circuit 9 sequentially supplies a drive signal that serves as an ON potential (drive potential) of the switching elements 1 to the scan line SCL(n) coupled to the pixels Pix arranged in the X direction (first direction). In other words, the scan circuit 9 simultaneously supplies the drive signal to the pixels Pix arranged in the X direction (first direction). The scan circuit 9 sequentially supplies the drive signal to the pixels Pix arranged in the Y direction (second direction).

The signal output circuit 8 sequentially supplies a pixel signal that serve as data of each of pixels corresponding to the pixels Pix (hereinafter, also referred to as “pixel data”) to the signal line SDL(m) coupled to the pixels Pix arranged in the Y direction (second direction). In other words, the signal output circuit 8 sequentially supplies the pixel data to the pixels Pix arranged in the Y direction (second direction). The signal output circuit 8 simultaneously supplies the pixel data to the pixels Pix arranged in the X direction (first direction).

When the scan circuit 9 supplies the drive signal to the scan line SCL(n) and the switching elements 1 of the pixels Pix arranged in the X direction (first direction) are controlled to be on, the signal output circuit 8 outputs the pixel signals to the signal lines SDL(m) to charge the liquid crystals 3 (fine particles 52) serving as a storage capacitor and a capacitive load provided between the pixel electrodes 2 of the pixels Pix arranged in the X direction (first direction) and the common electrode 6. As a result, a voltage corresponding to the pixel data of each of the pixels Pix arranged in the X direction (first direction) is applied between the pixel electrode 2 of the pixel Pix and the common electrode 6. The scan circuit 9 sequentially supplies the drive signal to the scan lines SCL(n) arranged in the Y direction (second direction), and the signal output circuit 8 supplies the pixel data corresponding to the pixels Pix coupled to the scan lines SCL(n) supplied with the drive signals by the scan circuit 9. As a result, the pixel data of an image for one sub-frame (one of a plurality of monochromatic images constituting an image for one frame) is written.

After the switching element 1 is turned off, the voltage applied between pixel electrode 2 and the common electrode 6 is held by the liquid crystals 3 (fine particles 52) serving as the storage capacitor and the capacitive load. The degree of scattering of the liquid crystals 3 (fine particles 52) is controlled according to the voltage applied between the pixel electrode 2 of each of the pixels Pix and the common electrode 6. For example, the liquid crystal 3 may be polymer-dispersed liquid crystals that increase in degree of scattering with increase in the voltage applied between the pixel electrode 2 of each of the pixels Pix and the common electrode 6, or may be polymer-dispersed liquid crystals that increase in degree of scattering with decrease in the voltage applied between the pixel electrode 2 of each of the pixels Pix and the common electrode 6.

As illustrated in FIG. 3, the light source device L is provided on a lateral side of the display panel P (lower side of the display panel P in FIG. 2). The light source device L includes a light source 11 that emits light to a side surface of the display panel P and a light source drive circuit 12 that controls the light source 11. The light source 11 includes a first light source 11R, a second light source 11G, and a third light source 11B.

The first light source 11R, the second light source 11G, and the third light source 11B each emit light under the control of the light source drive circuit 12. The first light source 11R, the second light source 11G, and the third light source 11B are light sources using light-emitting elements such as light-emitting diodes (LEDs), but are not limited to such light sources, and only need to be light sources controllable in light emission timing.

The light source drive circuit 12 controls the light emission timing of the first light source 11R, the second light source 11G, and the third light source 11B under the control of the timing controller 13. In the present disclosure, the emission color of the first light source 11R (first color) is red (R), the emission color of the second light source 11G (second color) is green (G), and the emission color of the third light source 11B (third color) is blue (B).

When the light is emitted from the light source 11, the display area 7 is irradiated by the light (first color, second color, and third color) emitted from one side surface side in the Y direction. Each of the pixels Pix transmits or scatters the light emitted from the one side surface side in the Y direction. The degree of scattering of the liquid crystals 3 for each of the pixels Pix depends on the state of the liquid crystals 3 controlled according to the pixel signal for each of the pixels Pix.

The timing controller 13 is a circuit that controls the operation timing of the signal output circuit 8, the scan circuit 9, the VCOM drive circuit 10, and the light source drive circuit 12. In the present disclosure, the timing controller 13 operates based on signals received via the image processing circuit 70.

The image processing circuit 70 outputs signals based on display image data to the signal output circuit 8 and the timing controller 13. When the pixel data is assumed to be data indicating red-green-blue (RGB) gradation values assigned to one of the pixels Pix provided in the display area 7, the display image data supplied to the image processing circuit 70 to output an image for display is a set of a plurality of pieces of the pixel data for the respective pixels Pix in the display area 7. The image processing circuit 70 may be provided on one of the substrates included in the display panel P, may be mounted on a flexible printed circuit board provided with, for example, wiring extending from the display panel P, or may be provided outside the display panel P.

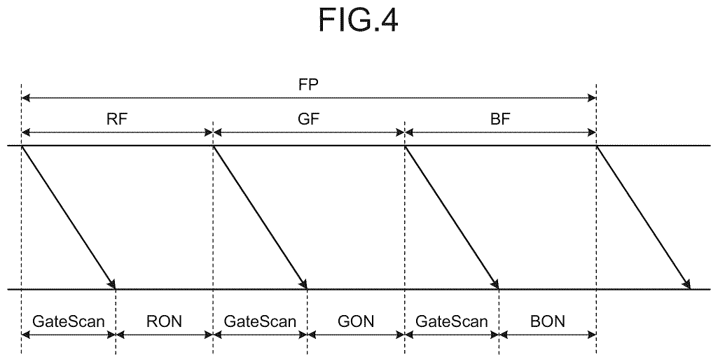

FIG. 4 is a timing diagram illustrating sub-frame periods and light emission periods in a one-frame period during which the display image data is displayed. In FIG. 4, an image display period FP for one frame is set to 20 ms. In this case, the image display frame rate of the display device 100 is set to 50 frames per second (fps).

In the display device 100 that performs the display output using the FSC system, the image display period FP for one frame based on the display image data is divided into a first sub-frame period RF, a second sub-frame period GF, and a third sub-frame period BF, as illustrated in FIG. 4. The first sub-frame period RF, the second sub-frame period GF, and the third sub-frame period BF are each set to 6.67 ms.

During a vertical scan period GateScan (first period) of the first sub-frame period RF, the pixel data corresponding to an output gradation value of each of the pixels Pix corresponding to the first color (red (R)) of the display image data is written. As a result, a voltage corresponding to the pixel data for each of the pixels Pix is applied to the pixel electrode 2 of the pixel Pix, and the scattering state of the liquid crystals 3 for each of the pixels Pix is controlled according to the voltage applied to the pixel electrode 2 of the pixel Pix. The vertical scan period GateScan (first period) of the first sub-frame period RF is set to 2.5 ms, for example.

The first light source 11R emits light during a subsequent light emission period RON (second period). During this light emission period RON (second period), light in the first color (red (R)) corresponding to the pixel data for each of the pixels Pix written in the previous vertical scan period GateScan is scattered and displayed.

During the vertical scan period GateScan (first period) of the second sub-frame period GF, the pixel data corresponding to an output gradation value of each of the pixels Pix corresponding to the second color (green (G)) of the display image data is written. As a result, a voltage corresponding to the pixel data for each of the pixels Pix is applied to the pixel electrode 2 of the pixel Pix, and the scattering state of the liquid crystals 3 for each of the pixels Pix is controlled according to the voltage applied to the pixel electrode 2 of the pixel Pix. The vertical scan period GateScan (first period) of the second sub-frame period GF is set to 2.5 ms, for example.

The second light source 11G emits light during a subsequent light emission period GON (second period). During this light emission period GON (second period), light in the second color (green (G)) corresponding to the pixel data for each of the pixels Pix written in the previous vertical scan period GateScan is scattered and displayed.

During the vertical scan period GateScan (first period) of the third sub-frame period BF, the pixel data corresponding to an output gradation value of each of the pixels Pix corresponding to the third color (blue (B)) of the display image data is written. As a result, a voltage corresponding to the pixel data for each of the pixels Pix is applied to the pixel electrode 2 of the pixel Pix, and the scattering state of the liquid crystals 3 for each of the pixels Pix is controlled according to the voltage applied to the pixel electrode 2 of the pixel Pix. The vertical scan period GateScan (first period) of the third sub-frame period BF is set to 2.5 ms, for example.

The third light source 11B emits light during a subsequent light emission period BON (second period). During this light emission period BON (second period), light in the third color (blue (B)) corresponding to the pixel data for each of the pixels Pix written in the previous vertical scan period GateScan is scattered and displayed.

In the display device 100 based on the FSC system described above, an image in which three colors of the first color (red (R)), the second color (green (G)), and the third color (blue (B)) are combined (mixed) is recognized due to an afterimage phenomenon caused by time limitation of resolution in a human eye. Since the display device 100 based on the FSC system does not require a color filter for each of the pixels Pix, light transmittance in the display area 7 can be made higher.

Referring back to FIG. 1, the imaging device 300 is a digital camera including an imaging element and an imaging lens or the like that focuses light onto the imaging element. Examples of the imaging element include solid-state image sensors such as complementary metal-oxide-semiconductor (CMOS) image sensors, but are not limited thereto, and may include charge-coupled device (CCD) image sensors.

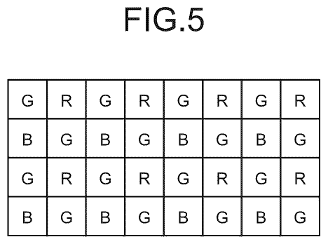

An image sensor includes color filters that selectively transmit the first color (red (R)), the second color (green (G)), and the third color (blue (B)). FIG. 5 is a diagram illustrating a color filter array of the image sensor.

The color filter array of the image sensor illustrated in FIG. 5 exemplifies a Bayer array that includes primary color filters of three colors of red (R), green (G), and blue (B) and in which a combination of four pixels of R, G, G, and B is regularly repeated (specifically, an array obtained by arranging one first color (red (R)), one third color (blue (B)), and two second colors (green (G)) in 2×2 pixels arranged in the vertical and horizontal directions). The color filter array of the image sensor illustrated in FIG. 5 is exemplary and is not limited to the array illustrated in FIG. 5.

As illustrated in FIG. 1, in the present disclosure, the imaging device 300 is provided with the display device 100 of the FSC system interposed between the imaging device 300 and a subject PA, who is, for example, a participant in a teleconferencing system. More preferably, the imaging system 200 according to the embodiment is provided with the imaging device 300 on an extended line of a line of sight A when the display panel P is seen from the subject PA.

An area indicated by long dashed short dashed lines in FIG. 1 illustrates an imaging area of the imaging device 300. An image of the subject PA passes through the display panel P, forms an image on the imaging element of the imaging device 300, and is acquired as image data. In the following description, the image data acquired by the imaging device 300 is also referred to as “imaged data”. Specifically, when a one-frame imaging period FI for acquiring the imaged data is set to, for example, 20 ms that is the same as the image display period FP for one frame in the display device 100, the imaging frame rate in the imaging device 300 is set to 50 fps.

Synchronization control between image display timing in the display device 100 and image data acquisition timing (exposure timing) in the imaging device 300 is performed, for example, by the display device 100. In that case, synchronization signals output from the display device 100 are received by the imaging device 300 (refer to FIG. 1). The synchronization control between the image display timing in the display device 100 and the image data acquisition timing (exposure timing) in the imaging device 300 is not limited to this configuration, and may be performed, for example, by the imaging device 300. In that case, the synchronization signals output from the imaging device 300 are received by the display device 100.

The imaged data acquired by the imaging device 300 is distributed as video data via a network 400, for example, to information terminal devices 500 of participants in the teleconferencing system. Examples of the information terminal devices 500 include, but are not limited to, desktop or notebook personal computers. The imaging system 200 according to the embodiment may be configured, for example, as a display, a web camera, and the like included in each of the information terminal devices 500.

In the imaging system 200 according to the embodiment described above, the imaging device 300 captures the image of the subject PA transmitted through the display panel P. Therefore, the display timing of the display image data (hereinafter, also referred to as “image display timing”) in the display device 100 and the acquisition timing of the imaged data in the imaging device 300 need be controlled so that light of the display image data displayed on the display device 100 does not affect the imaged data acquired by the imaging device 300. The following describes the acquisition timing of the imaged data in the imaging system 200 according to the embodiment.

### First Embodiment

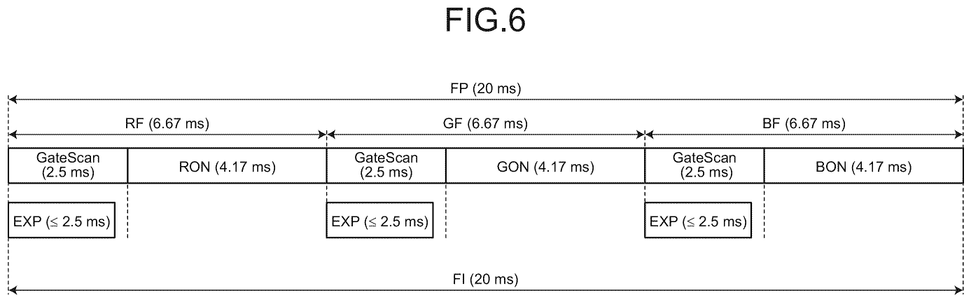

FIG. 6 is a timing diagram illustrating an example of the acquisition timing of the imaged data in the imaging system according to a first embodiment of the present disclosure.

In the example illustrated in FIG. 6, the image display timing in the display device 100 is the same as that of the timing diagram described with reference to FIG. 4. That is, the image display period FP for one frame is divided into the first sub-frame period RF, the second sub-frame period GF, and the third sub-frame period BF.

In FIG. 6, the image display period FP for one frame is set to 20 ms. In this case, the image display frame rate of the display device 100 is set to 50 fps. The first sub-frame period RF, the second sub-frame period GF, and the third sub-frame period BF are each set to 6.67 ms, and the vertical scan period GateScan (first period) of each of the sub-frame periods is set to 2.5 ms, for example.

In the first embodiment, the imaging device 300 generates the imaged data of the subject PA using exposure data acquired during an exposure period EXP that overlaps the vertical scan period GateScan (first period) of each of the sub-frame periods. The vertical scan period GateScan (first period) of each of the sub-frame periods is a period when the light source device L (first light source 11R, second light source 11G, and third light source 11B) stop emitting light. Therefore, the light of the display image data can be prevented from affecting the imaged data acquired by the imaging device 300. As a result, the imaged data that is less affected by the display image data can be acquired.

The exposure period EXP is set equal to or shorter than the vertical scan period GateScan (first period) of each of the sub-frame periods. Specifically, in the example illustrated in FIG. 6, the exposure period EXP is set to 2.5 ms or shorter.

In the example illustrated in FIG. 6, the imaging device 300 first acquires first exposure data during the exposure period EXP overlapping the vertical scan period GateScan (first period) of the first sub-frame period RF.

The imaging device 300 then acquires second exposure data during the exposure period EXP overlapping the vertical scan period GateScan (first period) of the second sub-frame period GF.

The imaging device 300 then acquires third exposure data during the exposure period EXP overlapping the vertical scan period GateScan (first period) of the third sub-frame period BF.

The imaging device 300 then combines the first exposure data, the second exposure data, and the third exposure data to generate the imaged data of the one-frame imaging period FI. The actual exposure period in the acquisition timing of the imaged data illustrated in FIG. 6 corresponds to a length obtained by summing the exposure periods EXP that overlap the vertical scan periods GateScan (first periods) of the respective sub-frame periods in which the first exposure data, the second exposure data, and the third exposure data are acquired. Specifically, in the example illustrated in FIG. 6, the actual exposure time is 7.5 ms or shorter.

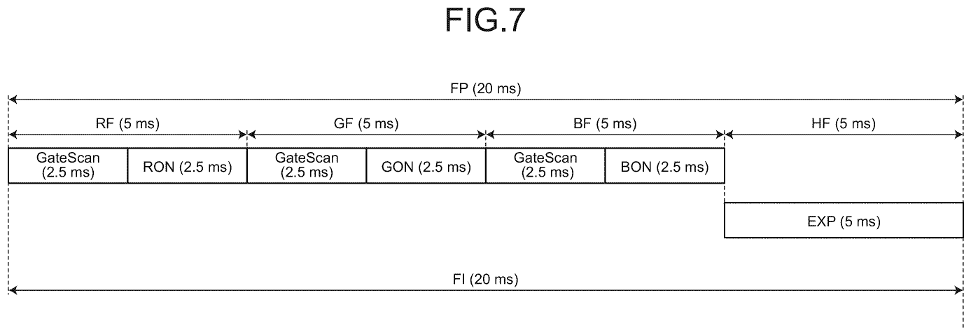

FIG. 7 is a timing diagram illustrating an example of the acquisition timing of the imaged data according to a comparative example.

In the acquisition timing of the imaged data according to the comparative example illustrated in FIG. 7, an example is illustrated in which a non-display period HF of the display device 100 is provided after the third sub-frame period BF, and the exposure period EXP of the imaging device 300 is provided in the non-display period HF. Even when the acquisition timing of the imaged data according to the comparative example illustrated in FIG. 7 is applied, the imaged data that is less affected by the display image data can be acquired.

However, in the comparative example illustrated in FIG. 7, when the image display period FP for one frame in the display device 100 is set to 20 ms (50 fps) that is the same as that of the first embodiment illustrated in FIG. 6, the light emission period (second period) of each of the sub-frame periods becomes shorter. In other words, the period in which the light source device L is off is relatively shortened in the image display period FP for one frame. In the comparative example illustrated in FIG. 7, when the one-frame imaging period FI in the imaging device 300 is set to 20 ms (50 fps) that is the same as that of the first embodiment illustrated in FIG. 6, the exposure period EXP is shortened relative to the one-frame imaging period FI.

In contrast, in the acquisition timing of the imaged data according to the first embodiment, the imaged data of the subject PA is generated by combining a plurality of pieces of the exposure data acquired in the exposure periods EXP overlapping the vertical scan periods GateScan (first periods) of the respective sub-frame periods. As a result, the light emission period (second period) of each of the sub-frame periods can be made relatively longer than in the comparative example illustrated in FIG. 7. Thus, the luminance of the displayed image of the display device 100 can be made higher than in the comparative example. In addition, the actual exposure period can be lengthened relative to the one-frame imaging period FI compared with the acquisition timing of the imaged data according to the comparative example illustrated in FIG. 7. Thus, the luminance of the image captured by the imaging device 300 can be made higher than in the comparative example.

### Modification

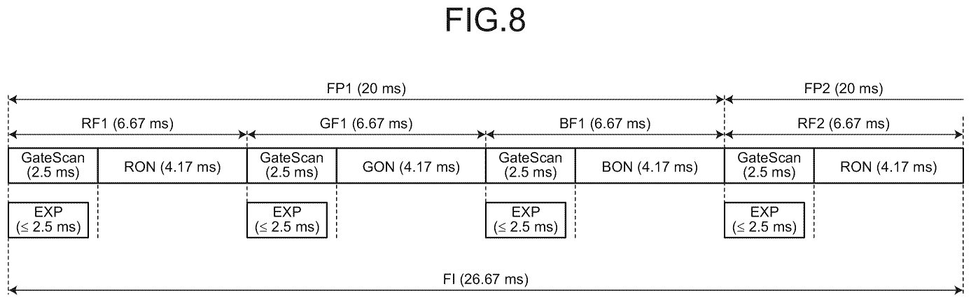

FIG. 8 is a timing diagram illustrating an example of the acquisition timing of the imaged data according to a modification of the first embodiment. In the present modification, the same description as that of the acquisition timing of the imaged data according to the first embodiment may be omitted.

In the example illustrated in FIG. 8, the imaging device 300 first acquires the first exposure data during the exposure period EXP overlapping the vertical scan period GateScan (first period) of a first sub-frame period RF1 in an image display period FP1.

The imaging device 300 then acquires the second exposure data during the exposure period EXP overlapping the vertical scan period GateScan (first period) of a second sub-frame period GF1.

The imaging device 300 then acquires the third exposure data during the exposure period EXP overlapping the vertical scan period GateScan (first period) of a third sub-frame period BF1.

The imaging device 300 then acquires fourth exposure data during the exposure period EXP overlapping the vertical scan period GateScan (first period) of a first sub-frame period RF2 in an image display period FP2 of the next frame.

The imaging device 300 then combines the first exposure data, the second exposure data, the third exposure data, and the fourth exposure data to generate the imaged data of the one-frame imaging period FI (26.67 ms). The actual exposure period in the acquisition timing of the imaged data illustrated in FIG. 8 corresponds to a length obtained by summing the exposure periods EXP that overlap the vertical scan periods GateScan (first periods) of the respective sub-frame periods in which the first exposure data, the second exposure data, the third exposure data, and the fourth exposure data are acquired. Specifically, in the example illustrated in FIG. 8, the actual exposure time is 10 ms or shorter.

In the acquisition timing of the imaged data according to the modification of the first embodiment illustrated in FIG. 8, the imaging frame rate (37.5 fps in this example) is lower than the image display frame rate (50 fps in this example), but the actual exposure time can be made longer than in the first embodiment. Thus, the luminance of the image captured by the imaging device 300 can be made higher than in the first embodiment.

In the first embodiment, the example has been illustrated in which the imaged data is generated by combining three pieces of the exposure data acquired in the exposure periods EXP that overlap the vertical scan periods GateScan (first periods) of three sub-frame periods. In the modification of the first embodiment, the example has been illustrated in which the imaged data is generated by combining four pieces of the exposure data acquired in the exposure periods EXP that overlap the vertical scan periods GateScan (first periods) of four sub-frame periods. The present disclosure is, however, not limited to these examples. For example, the imaged data may be generated by combining a plurality of pieces of the exposure data acquired in the exposure periods EXP that overlap the vertical scan periods GateScan (first periods) of five or more sub-frame periods.

### Second Embodiment

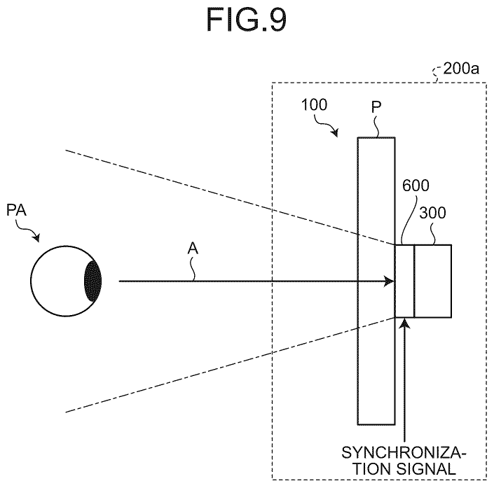

FIG. 9 is a diagram illustrating a schematic configuration of an imaging system according to a second embodiment of the present disclosure. In the present embodiment, detailed descriptions may be omitted for the same configurations as those of the imaging system 200.

As illustrated in FIG. 9, an imaging system 200a according to the second embodiment includes a liquid crystal shutter 600 provided between the display panel P and the imaging device 300. The liquid crystal shutter 600 is provided on the optical axis of the imaging device 300. The liquid crystal shutter 600 and the imaging device 300 overlap each other on an extended line of the line of sight A when the display panel P is seen from the subject PA.

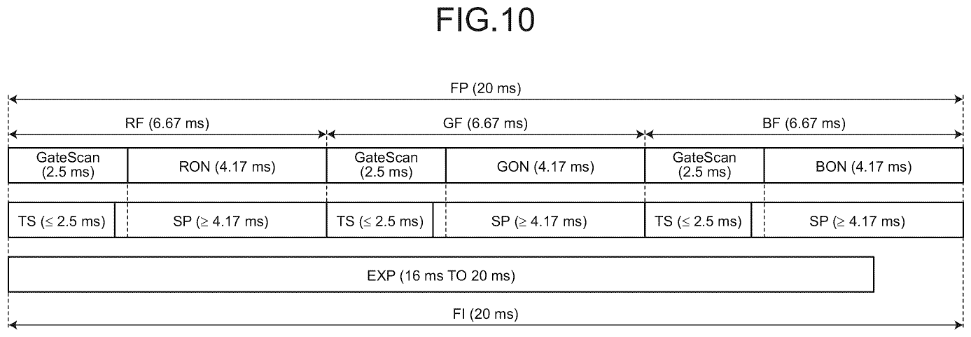

FIG. 10 is a timing diagram illustrating an example of the acquisition timing of the imaged data according to the second embodiment. In the present embodiment, the same description as that of the acquisition timing of the imaged data according to the first embodiment and the modification thereof may be omitted.

In the example illustrated in FIG. 10, the image display timing in the display device 100 is the same as that of the timing diagram described in the first embodiment. That is, the image display period FP for one frame is divided into the first sub-frame period RF, the second sub-frame period GF, and the third sub-frame period BF.

In FIG. 10, in the same way as in the first embodiment, the image display period FP for one frame is set to 20 ms. In this case, the image display frame rate of the display device 100 is set to 50 fps. The first sub-frame period RF, the second sub-frame period GF, and the third sub-frame period BF are each set to 6.67 ms, and the vertical scan period GateScan (first period) of each of the sub-frame periods is set to 2.5 ms, for example.

The liquid crystal shutter 600 transmits light from the subject PA during a light-transmitting period TS overlapping the vertical scan period GateScan (first period) of each of the sub-frame periods, and blocks the light from the subject PA during a light-blocking period SP overlapping the light emission period (second period) of each of the sub-frame periods. The light-transmitting period TS is set to the vertical scan period GateScan (first period) of each of the sub-frame periods or shorter. Specifically, in the example illustrated in FIG. 10, light-transmitting period TS is set to 2.5 ms or shorter.

Synchronization control of the liquid crystal shutter 600 is performed, for example, by the display device 100. In that case, synchronization signals output from the display device 100 are received by the liquid crystal shutter 600 (refer to FIG. 9). The synchronization control of the liquid crystal shutter 600 is not limited to this configuration, and may be performed, for example, by the imaging device 300. In that case, the synchronization signals output from the imaging device 300 are received by the liquid crystal shutter 600.

The imaging device 300 generates the imaged data of the subject PA using the exposure data acquired during the light-transmitting period TS that overlaps the vertical scan period GateScan (first period) of each of the sub-frame periods. Thus, the imaged data that is less affected by the display image data can be acquired in the same way as in the first embodiment.

In the second embodiment, the exposure period EXP of the imaging device 300 is a period that overlaps the vertical scan periods GateScan (first period) of the respective sub-frame periods. Specifically, in the example illustrated in FIG. 10, the exposure period EXP is, for example, 16 ms to 20 ms. In the second embodiment, the exposure period EXP of the imaging device 300 is continuous over both the vertical scan periods GateScan (first period) of the respective sub-frame periods and the light emission periods (second periods) of the respective sub-frame periods, but the actual exposure period is a period obtained by summing the light-transmitting periods TS during which the liquid crystal shutter 600 transmits light.

In the example illustrated in FIG. 10, the imaging device 300 first acquires the first exposure data during the light-transmitting period TS overlapping the vertical scan period GateScan (first period) of the first sub-frame period RF.

The imaging device 300 then acquires the second exposure data during the light-transmitting period TS overlapping the vertical scan period GateScan (first period) of the second sub-frame period GF.

The imaging device 300 then acquires the third exposure data during the light-transmitting period TS overlapping the vertical scan period GateScan (first period) of the third sub-frame period BF.

The imaging device 300 then combines the first exposure data, the second exposure data, and the third exposure data to generate the imaged data of the one-frame imaging period FI. The actual exposure period in the acquisition timing of the imaged data illustrated in FIG. 10 corresponds to a length obtained by summing the light-transmitting periods TS that overlap the vertical scan periods GateScan (first periods) of the respective sub-frame periods in which the first exposure data, the second exposure data, and the third exposure data are acquired. Specifically, in the example illustrated in FIG. 10, the actual exposure time is 7.5 ms or shorter.

In the acquisition timing of the imaged data according to the second embodiment, the imaged data of the subject PA is generated by combining a plurality of pieces of the exposure data acquired in the light-transmitting periods TS of the liquid crystal shutter 600 overlapping the vertical scan periods GateScan (first periods) of the respective sub-frame periods. As a result, the light emission period (second period) of each of the sub-frame periods can be made relatively longer than in the comparative example illustrated in FIG. 7. Thus, the luminance of the displayed image of the display device 100 can be made higher than in the comparative example. In addition, the actual exposure period can be lengthened relative to the one-frame imaging period FI compared with the acquisition timing of the imaged data according to the comparative example illustrated in FIG. 7. Thus, the luminance of the image captured by the imaging device 300 can be made higher than in the comparative example.

### Modification

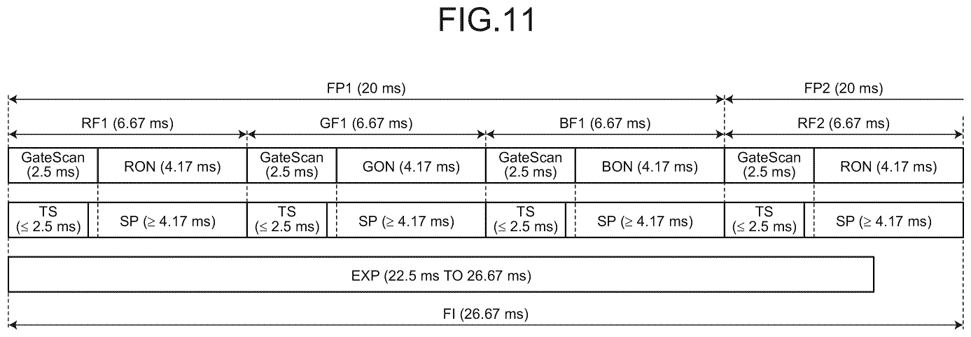

FIG. 11 is a timing diagram illustrating an example of the acquisition timing of the imaged data according to a modification of the second embodiment. In the present modification, the same description as that of the acquisition timing of the imaged data according to the second embodiment may be omitted.

In the modification of the second embodiment, the exposure period EXP of the imaging device 300 is a period that overlaps the first sub-frame period RF1, a second sub-frame period GF1, and a third sub-frame period BF1 of the image display period FP1 and the vertical scan period GateScan (first period) of the first sub-frame period RF2 of the image display period FP2 in the next frame. Specifically, in the example illustrated in FIG. 11, the exposure period EXP is, for example, 22.5 ms to 26.67 ms. In also the modification of the second embodiment, the exposure period EXP of the imaging device 300 is continuous over both the vertical scan periods GateScan (first period) of the respective sub-frame periods and the light emission periods (second periods) of the respective sub-frame periods, but the actual exposure period is a period obtained by summing the light-transmitting periods TS during which the liquid crystal shutter 600 transmits light.

In the example illustrated in FIG. 11, the imaging device 300 first acquires the first exposure data during the light-transmitting period TS overlapping the vertical scan period GateScan (first period) of the first sub-frame period RF1 in the image display period FP1.

The imaging device 300 then acquires the second exposure data during the light-transmitting period TS overlapping the vertical scan period GateScan (first period) of the second sub-frame period GF1.

The imaging device 300 then acquires the third exposure data during the light-transmitting period TS overlapping the vertical scan period GateScan (first period) of the third sub-frame period BF1.

The imaging device 300 then acquires the fourth exposure data during the light-transmitting period TS overlapping the vertical scan period GateScan (first period) of the first sub-frame period RF2 in the image display period FP2 of the next frame.

The imaging device 300 then combines the first exposure data, the second exposure data, the third exposure data, and the fourth exposure data to generate the imaged data of the one-frame imaging period FI (26.67 ms). The actual exposure period in the acquisition timing of the imaged data illustrated in FIG. 11 corresponds to a length obtained by summing the light-transmitting periods TS that overlap the vertical scan periods GateScan (first periods) of the respective sub-frame periods in which the first exposure data, the second exposure data, the third exposure data, and the fourth exposure data are acquired. Specifically, in the example illustrated in FIG. 11, the actual exposure time is 10 ms or shorter.

In the acquisition timing of the imaged data according to the modification of the second embodiment illustrated in FIG. 11, the imaging frame rate (37.5 fps in this example) is lower than the image display frame rate (50 fps in this example), but the actual exposure time can be made longer than in the second embodiment. Thus, the luminance of the image captured by the imaging device 300 can be made higher than in the second embodiment.

In the second embodiment, the example has been illustrated in which the imaged data is generated by combining three pieces of the exposure data acquired in the light-transmitting periods TS that overlap the vertical scan periods GateScan (first periods) of the three sub-frame periods. In the modification of the second embodiment, the example has been illustrated in which the imaged data is generated by combining four pieces of the exposure data acquired in the light-transmitting periods TS that overlap the vertical scan periods GateScan (first periods) of four sub-frame periods. The present disclosure is, however, not limited to these examples. For example, the imaged data may be generated by combining a plurality of pieces of the exposure data acquired in the light-transmitting periods TS that overlap the vertical scan periods GateScan (first periods) of five or more sub-frame periods.

The component part that transmits or blocks light from the subject PA is not limited to the liquid crystal shutter. Specifically, the imaging system may have a configuration including, for example, a mechanical shutter instead of the liquid crystal shutter 600.

### Third Embodiment

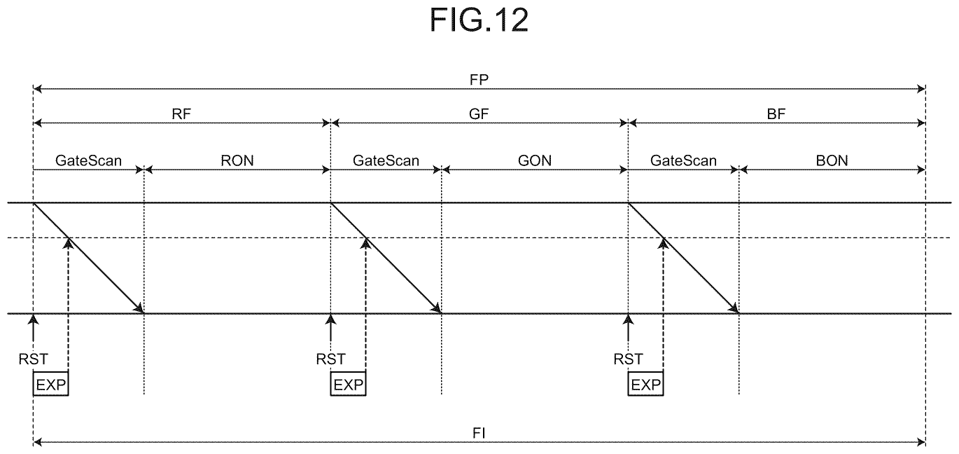

FIG. 12 is a timing diagram illustrating an example of the acquisition timing of the imaged data according to a third embodiment of the present disclosure. In the present embodiment, detailed descriptions may be omitted for the same configurations as those of the imaging system 200. The same description as that of the acquisition timing of the imaged data according to the first embodiment and the modification thereof may be omitted.

In the third embodiment, all the pixels Pix of the display panel P are reset at a reset time RST immediately before the vertical scan period GateScan (first period) of each of the sub-frame periods.

Specifically, the signal output circuit 8 of the display device 100 supplies a common reset potential to all the pixels Pix of the display panel P at the reset time RST immediately before the vertical scan period GateScan (first period) of each of the sub-frame periods. This operation maximizes the light transmittance of the display panel P.

In the vertical scan period GateScan (first period) after the reset, the scan circuit 9 of the display device 100 sequentially supplies the drive signal to the scan line SCL(n), and the signal output circuit 8 supplies the pixel data corresponding to the pixels Pix coupled to the scan line SCL(n) supplied with the drive signal by the scan circuit 9, to the pixels Pix.

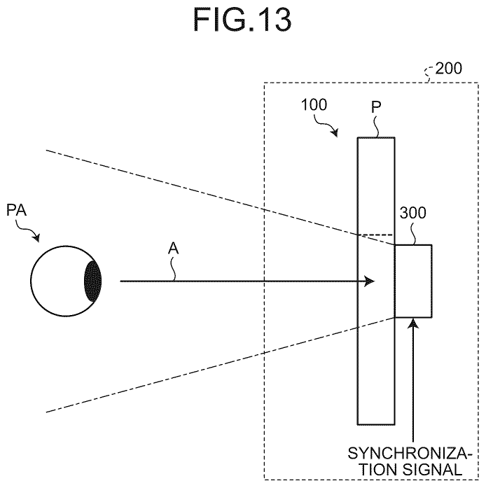

The imaging device 300 acquires the exposure data in the exposure period EXP overlapping the vertical scan period GateScan (first period) of each of the sub-frame periods. FIG. 13 is a diagram illustrating the imaging area that overlaps the display panel when the imaging device acquires the exposure data in the third embodiment.

In the vertical scan period GateScan after the reset time RST, the pixel data corresponding to the display image data is sequentially written to each of the pixels Pix of the display panel P. An area where the pixel data corresponding to the display image data is not written (area below a dashed line indicated in each of FIGS. 12 and 13) overlaps the imaging area of the imaging device 300 (area indicated by long dashed short dashed lines in FIG. 13). In the third embodiment, a period before the pixel data corresponding to the display image data is written in that area is set as the exposure period EXP. In other words, in the acquisition timing of the imaged data according to the third embodiment, when the exposure data is acquired, the imaging area of the imaging device 300 does not overlap the area where the pixel data corresponding to the display image data is written. As a result, the imaged data that is less affected by the display image data than in the first embodiment can be acquired.

FIG. 12 illustrates the example in which the imaged data is generated by combining three pieces of the exposure data acquired in the exposure periods EXP that overlap the vertical scan periods GateScan (first periods) of the three sub-frame periods. The present disclosure is, however, not limited to this example. For example, the imaged data may be generated by combining a plurality of pieces of the exposure data acquired in the exposure periods EXP that overlap the vertical scan periods GateScan (first periods) of four or more sub-frame periods.

### Modification

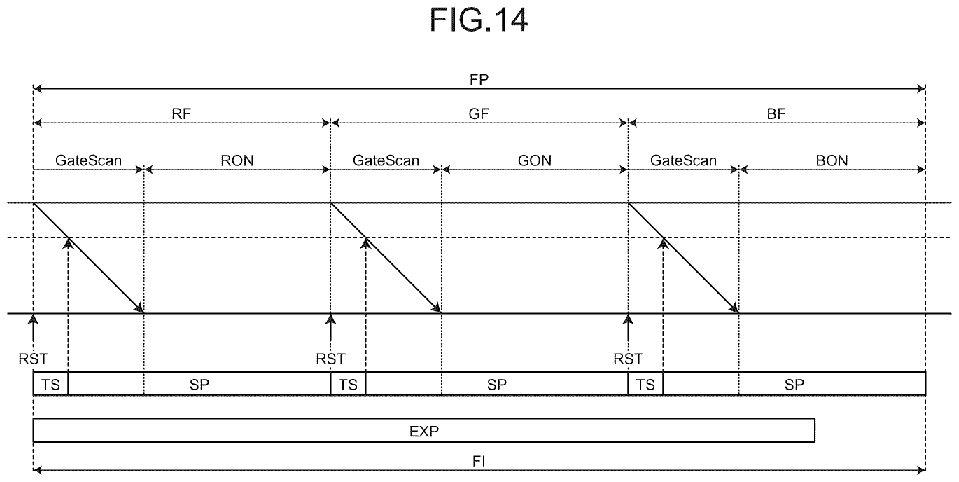

FIG. 14 is a timing diagram illustrating an example of the acquisition timing of the imaged data according to a modification of the third embodiment. In the present modification, detailed descriptions may be omitted for the same configurations as those of the imaging system 200. The same description as that of the acquisition timing of the imaged data according to the second embodiment and the modification thereof may be omitted.

In the modification of the third embodiment, all the pixels Pix of the display panel P are reset at the reset time RST immediately before the vertical scan period GateScan (first period) of each of the sub-frame periods.

Specifically, the signal output circuit 8 of the display device 100 supplies the common reset potential to all the pixels Pix of the display panel P at the reset time RST immediately before the vertical scan period GateScan (first period) of each of the sub-frame periods. This operation maximizes the light transmittance of the display panel P.

In the vertical scan period GateScan (first period) after the reset, the scan circuit 9 of the display device 100 sequentially supplies the drive signal to the scan line SCL(n), and the signal output circuit 8 supplies the pixel data corresponding to the pixels Pix coupled to the scan line SCL(n) supplied with the drive signal by the scan circuit 9, to the pixels Pix.

In also the modification of the third embodiment, in the same way as in the second embodiment, the exposure period EXP of the imaging device 300 is continuous over both the vertical scan periods GateScan (first period) of the respective sub-frame periods and the light emission periods (second periods) of the respective sub-frame periods, but the actual exposure period is a period obtained by summing the light-transmitting periods TS during which the liquid crystal shutter 600 transmits light.

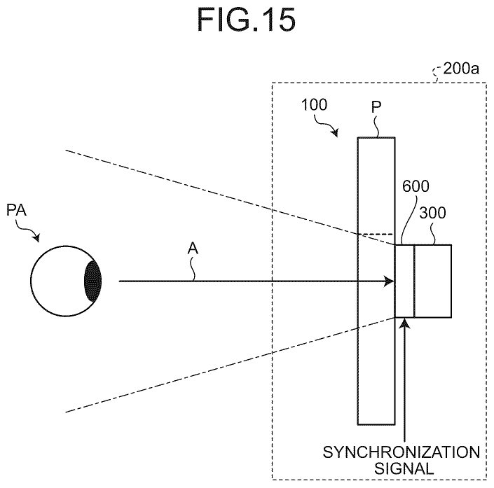

The imaging device 300 acquires the exposure data during the light-transmitting period TS overlapping the vertical scan period GateScan (first period) of each of the sub-frame periods. FIG. 15 is a diagram illustrating the imaging area that overlaps the display panel when the imaging device acquires the exposure data in the modification of the third embodiment.

In the vertical scan period GateScan after the reset period RST, the pixel data corresponding to the display image data is sequentially written to each of the pixels Pix of the display panel P. An area where the pixel data corresponding to the display image data is not written (area below a dashed line indicated in each of FIGS. 14 and 15) overlaps the imaging area of the imaging device 300 (area indicated by long dashed short dashed lines in FIG. 15). In the modification of the third embodiment, a period before the pixel data corresponding to the display image data is written in that area is set as the light-transmitting period TS. In other words, in the acquisition timing of the imaged data according to the modification of the third embodiment, when the exposure data is acquired, the imaging area of the imaging device 300 does not overlap the area where the pixel data corresponding to the display image data is written. As a result, the imaged data that is less affected by the display image data than in the second embodiment can be acquired.

FIG. 14 illustrates the example in which the imaged data is generated by combining three pieces of the exposure data acquired in the light-transmitting periods TS that overlap the vertical scan periods GateScan (first periods) of the three sub-frame periods. The present disclosure is, however, not limited to this example. For example, the imaged data may be generated by combining a plurality of pieces of the exposure data acquired in the light-transmitting periods TS that overlap the vertical scan periods GateScan (first periods) of four or more sub-frame periods.

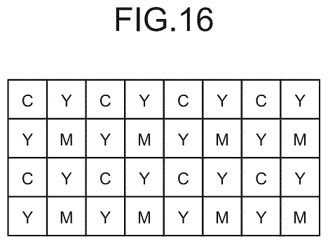

FIG. 16 is a diagram illustrating a modification of the color filter array of the image sensor. The color filter array of the image sensor illustrated in FIG. 16 illustrates a Bayer array that includes complementary color filters for three colors of yellow (Y), cyan (C), and magenta (M), and in which a combination of four pixels of C, Y, Y, and M is regularly repeated (specifically, an array obtained by arranging one cyan (C) color, one magenta (M) color, and two yellow (Y) colors in 2×2 pixels arranged in the vertical and horizontal directions). For example, an array in which a combination of four pixels of C, Y, G, and M is regularly repeated (specifically, an array obtained by arranging one cyan (C) color, one yellow (Y) color, one green (G) color, and one magenta (M) color in 2×2 pixels arranged in the vertical and horizontal directions) may be used instead of the color filter array of the image sensor illustrated in FIG. 16.

While the preferred embodiments have been described above, the present disclosure is not limited to such embodiments. The content disclosed in the embodiments is merely an example, and can be variously modified within the scope not departing from the gist of the present disclosure. For example, any modifications appropriately made within the scope not departing from the gist of the present disclosure also naturally belong to the technical scope of the present invention.

What is claimed is:

1. An imaging system comprising:
a display device that includes a display panel on which a plurality of pixels are arranged in a first direction and a second direction intersecting the first direction and a light source configured to emit light to a side surface of the display panel; and
an imaging device that is provided with the display panel interposed between the imaging device and a subject and is configured to capture an image of the subject transmitted through the display panel, wherein
the display device is configured to have:
a first period in which pixel data is written to the pixels; and
a second period in which the light source emits the light after the first period, and
the imaging device is configured to generate imaged data of the subject using exposure data acquired during the first period.

2. The imaging system according to claim 1, wherein
a one-frame period in which the image for one frame is displayed on the display panel includes:
a first sub-frame period in which display of a first color is performed;
a second sub-frame period in which display of a second color different from the first color is performed; and
a third sub-frame period in which display of a third color different from the first color and the second color is performed,
the light source includes:
a first light source configured to emit light in the second period of the first sub-frame period;
a second light source configured to emit light in the second period of the second sub-frame period; and
a third light source configured to emit light in the second period of the third sub-frame period, and
the imaging device is configured to generate the imaged data by combining first exposure data acquired in the first period of the first sub-frame period, second exposure data acquired in the first period of the second sub-frame period, and third exposure data acquired in the first period of the third sub-frame period.

3. The imaging system according to claim 1, further comprising a shutter that is provided between the display panel and the imaging device and is configured to block light in the second period, wherein
a one-frame period in which the image for one frame is displayed on the display panel includes:
a first sub-frame period in which display of a first color is performed;
a second sub-frame period in which display of a second color different from the first color is performed; and
a third sub-frame period in which display of a third color different from the first color and the second color is performed,
the light source includes:
a first light source configured to emit light in the second period of the first sub-frame period;
a second light source configured to emit light in the second period of the second sub-frame period; and
a third light source configured to emit light in the second period of the third sub-frame period, and
the imaging device is configured to generate the imaged data using exposure data acquired over the first period of the first sub-frame period, the first period of the second sub-frame period, and the first period of the third sub-frame period.

4. The imaging system according to claim 3, wherein the shutter is a liquid crystal shutter.

5. The imaging system according to claim 2, wherein a frame rate when the imaged data is acquired is equal to a frame rate when the image is displayed on the display panel.

6. The imaging system according to claim 3, wherein a frame rate when the imaged data is acquired is equal to a frame rate when the image is displayed on the display panel.

7. The imaging system according to claim 2, wherein a frame rate when the imaged data is acquired is lower than a frame rate when the image is displayed on the display panel.

8. The imaging system according to claim 3, wherein a frame rate when the imaged data is acquired is lower than a frame rate when the image is displayed on the display panel.

9. The imaging system according to claim 1, wherein
the display device includes:
a scan circuit configured to simultaneously supply a drive signal to the pixels arranged in the first direction and sequentially supply the drive signal to the pixels arranged in the second direction; and
a signal output circuit configured to supply the pixel data of the image to be displayed on the display panel to the pixels supplied with the drive signal,
all the pixels on the display panel are configured to be reset immediately before the first period, and
an area not supplied with the pixel data of the image to be displayed on the display panel in the first period overlaps an imaging area of the imaging device when the exposure data is acquired.

10. The imaging system according to claim 1, wherein the display panel is a liquid crystal panel in which polymer-dispersed liquid crystals are enclosed.
